(19) United States
(12) Patent Application Publication
(10) Pub. No.: US 2026/0322292 A1
(43) Pub. Date: Oct. 15, 2026

(54) ELECTRONIC CONTROL DEVICE

(71) Applicant: HITACHI ASTEMO, LTD., Hitachinaka-shi, Ibaraki (JP)

(72) Inventors: Yasuaki SATO, Hitachinaka-shi, Ibaraki (JP); Shigehisa AOYAGI, Hitachinaka-shi, Ibaraki (JP); Shogo MIYAMOTO, Hitachinaka-shi, Ibaraki (JP); Takaya TSUKAGOSHI, Hitachinaka-shi, Ibaraki (JP)

(73) Assignee: HITACHI ASTEMO, LTD., Hitachinaka-shi, Ibaraki (JP)

(21) Appl. No.: 19/111,160

(22) PCT Filed: Sep. 14, 2022
(86) PCT No.: PCT/JP2022/034430

§ 371 Date: Mar. 12, 2025

(51) Int. Cl. H02P 5/50; B60L 15/20

(52) U.S. Cl. CPC H02P 5/50; B60L 15/20; B60L 2240/421; B60L 2240/423

(57) ABSTRACT

The present disclosure provides an electronic control device capable of suppressing noise of an electric motor when changing the carrier frequency. An electronic control device controls an electric motor for driving a vehicle, and includes a switching condition memory 122, a traveling load calculator 121, a switching condition determination unit 123, and a frequency controller 124. The switching condition memory 122 stores a switching condition that a rotation speed of the electric motor is lower than a predetermined lower limit and a torque command of the electric motor is higher than a predetermined upper limit. The traveling load calculator 121 calculates the traveling load Lt of the vehicle on the basis of the rotation speed @ and the torque command Tc of the electric motor. The switching condition determination unit 123 determines whether a switching condition is satisfied after a predetermined time, on the basis of the traveling load Lt of the vehicle, and the rotation speed @ and torque command Tc of the electric motor. If the switching condition determination unit 123 determines that the switching condition is satisfied, the frequency controller 124 lowers the carrier frequency of the electric motor when the torque command of the electric motor is equal to or lower than the upper limit.

### TECHNICAL FIELD

The present disclosure relates to electronic control devices that control an electric motor.

### BACKGROUND ART

Conventionally inventions about power output devices that output power for driving have been known (see Patent Literature 1 below). This conventional power output device includes: a plurality of electric motors capable of outputting power for driving; a plurality of drive circuits each driving these motors; a power demand setting means for setting the power demand based on an operator's operation; and a control means for driving and controlling the plurality of drive circuits (e.g., Patent Literature 1 below, paragraph 0006, claim 1, and summary).

The plurality of drive circuits each have a switching element, and drive the plurality of electric motors by switching the switching elements. When all the plurality of drive circuits are in a normal state where the drive circuits function normally, the control means drives and controls the plurality of drive circuits to output a power based on the set power demand from the electric motors. If one of the drive circuits is in an abnormal state where the drive circuit cannot function normally, the control means drives and controls the plurality of drive circuits in the following manner.

That is, the control means drives and controls the drive circuits on the basis of the switching frequency of the switching element of the drive circuit in the abnormal state and the power from the electric motor driven by the drive circuit in the abnormal state. Specifically, the control means drives and controls the plurality of drive circuits so as to limit the power in priority to the switching frequency, and to output power based on the set power demand from the plurality of electric motors.

This conventional power output device reduces the load on the drive circuit in the abnormal state while suppressing noise caused by switching of the switching element of the drive circuit in the abnormal state. This achieves both of the favorable driving of the drive circuit and the suppression of noise caused by driving. This also satisfies the power demand regardless of whether any of the plurality of drive circuits is in a normal state (Patent Literature 1, paragraph 0007).

### CITATION LIST

### Patent Literature

Patent Literature 1: JP 2006-197717 A

### SUMMARY OF INVENTION

### Technical Problem

The above-described conventional power output device is configured to distribute torque among the plurality of electric motors until the temperature of the drive circuits reaches a temperature limit, for example. Thus, the carrier frequency may change while the electric motors are outputting high torque. If the carrier frequency changes while the electric motors are outputting high torque in this way, noise may be generated from the electric motors.

The present disclosure provides an electronic control device capable of suppressing noise of an electric motor when changing the carrier frequency.

### Solution to Problem

One aspect of the present disclosure relates to an electronic control device that controls at least one electric motor for driving a vehicle, and includes: a switching condition memory that stores a switching condition that a rotation speed of the at least one electric motor is lower than a predetermined lower limit and a torque command of the at least one electric motor is higher than a predetermined upper limit; a traveling load calculator that is configured to calculate a traveling load of the vehicle on a basis of a rotation speed and a torque command of the at least one electric motor; a switching condition determination unit that is configured to determine whether the at least one electric motor satisfies the switching condition after a predetermined time elapses, on the basis of the traveling load of the vehicle and the rotation speed and the torque command of the at least one electric motor; and a frequency controller that is configured to lower a carrier frequency of the at least one electric motor in response to a determination by the switching condition determination unit that the switching condition is satisfied, when the torque command of the at least one electric motor is equal to or lower than the upper limit.

### Advantageous Effects of Invention

The one aspect of the present disclosure provides an electronic control device capable of suppressing noise of an electric motor when changing the carrier frequency.

### BRIEF DESCRIPTION OF DRAWINGS

FIG. 1 is a block diagram showing one embodiment of an electronic control device according to the present disclosure.

FIG. 2 is a block diagram of a torque controller constituting the electronic control device of FIG. 1.

FIG. 3 is a block diagram of a three-phase current controller constituting the electronic control device of FIG. 1.

FIG. 4 are graphs illustrating a switching condition memory that is a part of the three-phase current controller in FIG. 3.

FIG. 5 are graphs illustrating a switching condition memory that is a part of the three-phase current controller in FIG. 3.

FIG. 6 is a block diagram of a PWM controller that is a part of the three-phase current controller of FIG. 3.

FIG. 7 is a flowchart showing the operation of the electronic control device of FIG. 1.

FIG. 8 shows a state transition of the vehicle under the control of the electronic control device of FIG. 1.

FIG. 9 are graphs illustrating torque commands and others of the electric motor in state (i) of FIG. 8.

FIG. 10 are graphs illustrating torque commands and others of the electric motor in state (ii) of FIG. 8.

FIG. 11 are graphs illustrating torque commands and others of the electric motor in state (iii) of FIG. 8.

FIG. 12 are graphs illustrating torque commands and others of the electric motor in state (iv) of FIG. 8.

FIG. 13 are graphs illustrating torque commands and others of the electric motor in state (v) of FIG. 8.

FIG. 14 are graphs illustrating torque commands and others of the electric motor in state (vi) of FIG. 8.

### DESCRIPTION OF EMBODIMENTS

The following describes one embodiment of an electronic control device according to the present disclosure, with reference to the drawings.

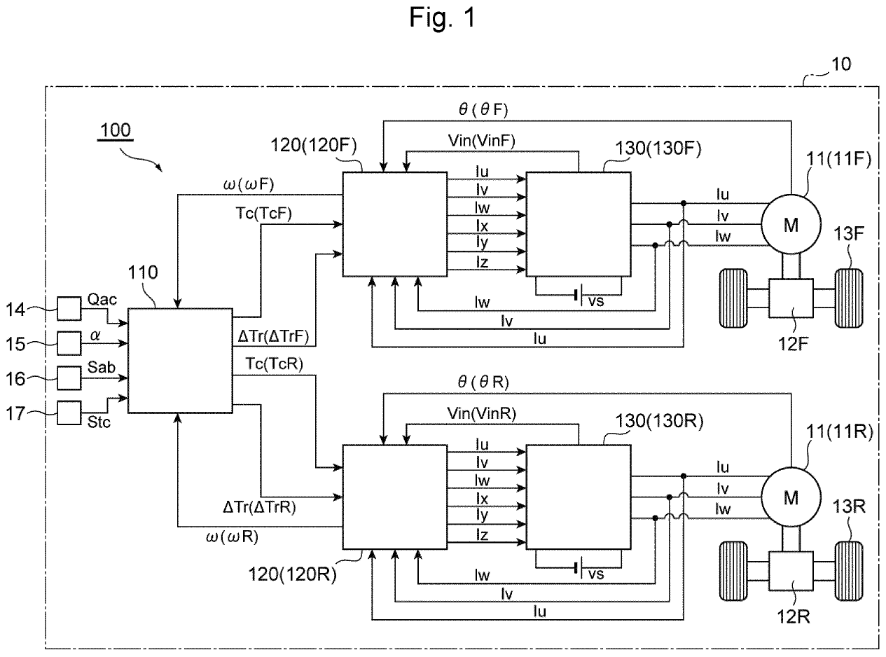

FIG. 1 is a block diagram showing one embodiment of the electronic control device according to the present disclosure. For instance, the electronic control device 100 of this embodiment is installed in a vehicle 10, such as an electric vehicle, hybrid vehicle, or fuel cell vehicle, and controls an electric motor 11 for travelling of the vehicle 10. Although not shown in FIG. 1, the vehicle 10 includes a steering device, a braking device, a power transmission device, an electricity storage device, and other devices that are typically provided in vehicles.

In the example shown in FIG. 1, the vehicle 10 has two electric motors 11 for driving: a first electric motor 11F that drives left and right front wheels 13F via a gear 12F, and a second electric motor 11R that drives left and right rear wheels 13R via a gear 12R. The vehicle 10 also has an accelerator position sensor 14 that detects the opening degree of an accelerator pedal, and an acceleration sensor 15 that detects the acceleration of the vehicle 10 in the forward/rearward direction.

In the example shown in FIG. 1, the vehicle 10 also includes an antilock braking system (ABS) controller 16 that constitutes an ABS, and a traction control system (TCS) controller 17 that constitutes a TCS. Although not shown in FIG. 1, the vehicle 10 has various sensors that a typical vehicle has. The vehicle 10 needs to have only at least one of the electric motors 11 for travelling, and may have four or more electric motors 11 (in-wheel motors) each of which drives the corresponding wheel 13.

For instance, the electronic control device 100 includes a plurality of microcontrollers and a plurality of electronic circuits including a plurality of electronic components, which are not shown. Each microcontroller constituting the electronic control device 100 has an input/output unit, a memory, a timer, a central processing unit (CPU), and other units. The electronic control device 100 controls the CPU to execute a program stored in a memory to implement various functions described later.

In the example shown in FIG. 1, the electronic control device 100 has a torque controller 110 and a three-phase current controller 120. The electronic control device 100 may further have an inverter 130. The electronic control device 100 has a first three-phase current controller 120F and a first inverter 130F that control the first electric motor 11F, and a second three-phase current controller 120R and a second inverter 130R that control the second electric motor 11R, for example. That is, one three-phase current controller 120 and one inverter 130 are provided for each electric motor 11.

For instance, the torque controller 110 receives an accelerator pedal operation amount Qac from the accelerator position sensor 14 and acceleration a in the front-rear direction of the vehicle 10 from the acceleration sensor 15. For instance, the torque controller 110 receives a control signal Sab related to antilock braking from the ABS controller 16 and a control signal Stc related to traction control from the TCS controller 17.

The torque controller 110 further receives rotation speed ω of the electric motor 11 from the three-phase current controller 120, for example. In the example shown in FIG. 1, the torque controller 110 receives the rotation speed ω F of the first electric motor 11F from the first three-phase current controller 120F and receives the rotation speed ωR of the second electric motor 11R from the second three-phase current controller 120R, for example.

For instance, the torque controller 110 outputs a torque command Tc and a torque change rate limit ΔTr on the basis of these input accelerator pedal operation amount Qac, acceleration a of the vehicle 10, rotation speed ω of the electric motor 11, and control signals Sab, Stc, and others. Specifically, the torque controller 110 outputs a torque command TcF and a torque change rate limit ΔTrF for the first electric motor 11F, and outputs a torque command TcR and a torque change rate limit ΔTrR for the second electric motor 11R.

The three-phase current controller 120 receives a torque command Te and a torque change rate limit ΔTr for the electric motor 11 from the torque controller 110. Specifically, the first three-phase current controller 120F receives the torque command TcF and torque change rate limit ΔTrF for the first electric motor 11F from the torque controller 110. The second three-phase current controller 120R receives the torque command TcR and torque change rate limit ΔTrR for the second electric motor 11R from the torque controller 110.

The three-phase current controller 120 receives the rotation angle θ from the electric motor 11. Specifically, the first three-phase current controller 120F receives the rotation angle OF from the first electric motor 11F, and the second three-phase current controller 120R receives the rotation angle θR from the second electric motor 11R.

The three-phase current controller 120 receives an inverter voltage Vin from the inverter 130. Specifically, the first three-phase current controller 120F receives an inverter voltage VinF from the first inverter 130F, and the second three-phase current controller 120R receives an inverter voltage VinR from the second inverter 130R.

The three-phase current controller 120 receives three-phase currents Iu, Iv, and Iw from the inverter 130. Specifically, the first and second three-phase current controllers 120F and 120R receive the three-phase currents Iu, Iv, and Iw from the first and second inverters 130F and 130R, respectively.

The three-phase current controller 120 outputs gate signals Iu, Iv, Iw, Ix, Iy, and Iz on the basis of these inputs. Specifically, the first three-phase current controller 120F outputs gate signals Iu, Iv, Iw, Ix, Iy, and Iz to the first inverter 130F, and the second three-phase current controller 120R outputs gate signals Iu, Iv, Iw, Ix, Iy, and Iz to the second inverter 130R.

For instance, the inverter 130 is connected to a power supply voltage Vs, and receives the gate signals Iu, Iv, Iw, Ix, Iy, and Iz from the three-phase current controller 120. Specifically, the first inverter 130F and the second inverter 130R receive gate signals Iu, Iv, Iw, Ix, Iy, Iz from the first three-phase current controller 120F and the second three-phase current controller 120R, respectively.

For instance, on the basis of these inputs, the inverter 130 outputs three-phase currents Iu, Iv, and Iw to the electric motor 11 and outputs an inverter voltage Vin to the three-phase current controller 120. Specifically, the first inverter 130F and the second inverter 130R output three-phase currents Iu, Iv, and Iw to the first electric motor 11F and the second electric motor 11R, respectively. The first inverter 130F and the second inverter 130R also output inverter voltages VinF and VinR to the first three-phase current controller 120F and the second three-phase current controller 120R, respectively.

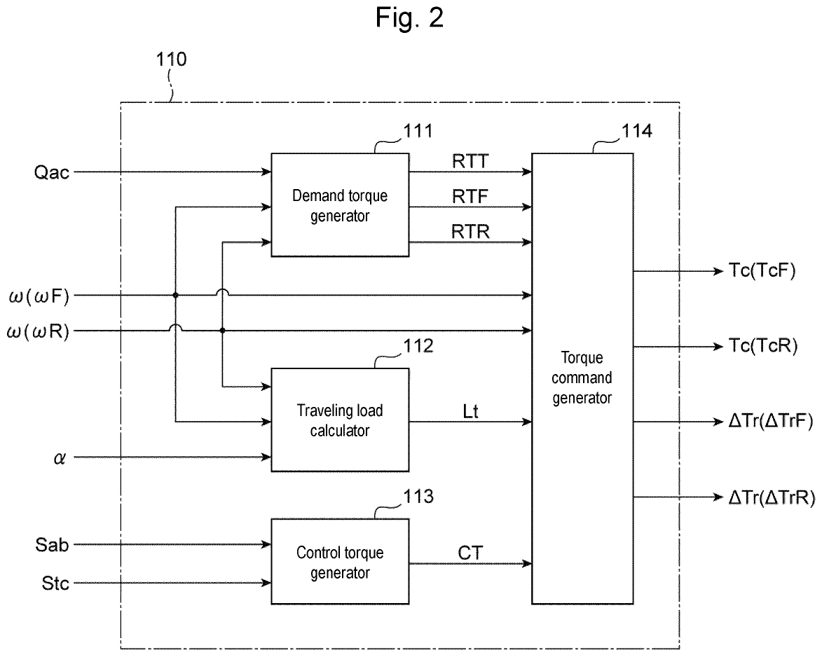

FIG. 2 is a block diagram of the torque controller 110 constituting the electronic control device 100 of FIG. 1. For instance, the torque controller 110 has a demand torque generator 111, a traveling load calculator 112, a control torque generator 113, and a torque command generator 114.

For instance, the demand torque generator 111 receives as input the accelerator pedal operation amount Qac and the rotation speed ω (ωF, ωR) of the electric motors 11. On the basis of these inputs, the demand torque generator 111 calculates a total demand torque RTT, a demand torque RTF of the first electric motor 11F, and a demand torque RTR of the second electric motor 11R, and outputs them to the torque command generator 114.

For instance, the traveling load calculator 112 receives as input the rotation speed ω (ωF, ωR) of the electric motors 11 and the acceleration a of the vehicle 10. The traveling load calculator 112 estimates a traveling resistance value due to a gradient from the rotation speed o of the electric motors 11 and the acceleration a of the vehicle 10. The traveling load calculator 112 further calculates the traveling load Lt of the vehicle 10 on the basis of the estimated traveling resistance value, and the weight and frontal projected area of the vehicle 10 stored in the memory, and outputs the calculated traveling load Lt to the torque command generator 114.

For instance, the control torque generator 113 receives as input the control signal Sab from the ABS controller 16 and the control signal Stc from the TCS controller 17. On the basis of these inputs, the control torque generator 113 calculates control torque CT required for controls such as anti-lock braking and traction control that stabilize the vehicle 10, and outputs it to the torque command generator 114.

For instance, the torque command generator 114 receives as input the total demand torque RTT, demand torque RTF, and demand torque RTR from the demand torque generator 111, and receives as input the rotation speeds ω of the electric motors 11 from their three-phase current controllers 120. The torque command generator 114 further receives as input the traveling load Lt from the traveling load calculator 112 and receives as input the control torque CT from the control torque generator 113. On the basis of these inputs, the torque command generator 114 calculates the torque commands Tc (TcF, TcR) and torque change rate limits ΔTr (ΔTrF, ΔTrR) for the electric motors 11 and outputs them to their three-phase current controllers 120.

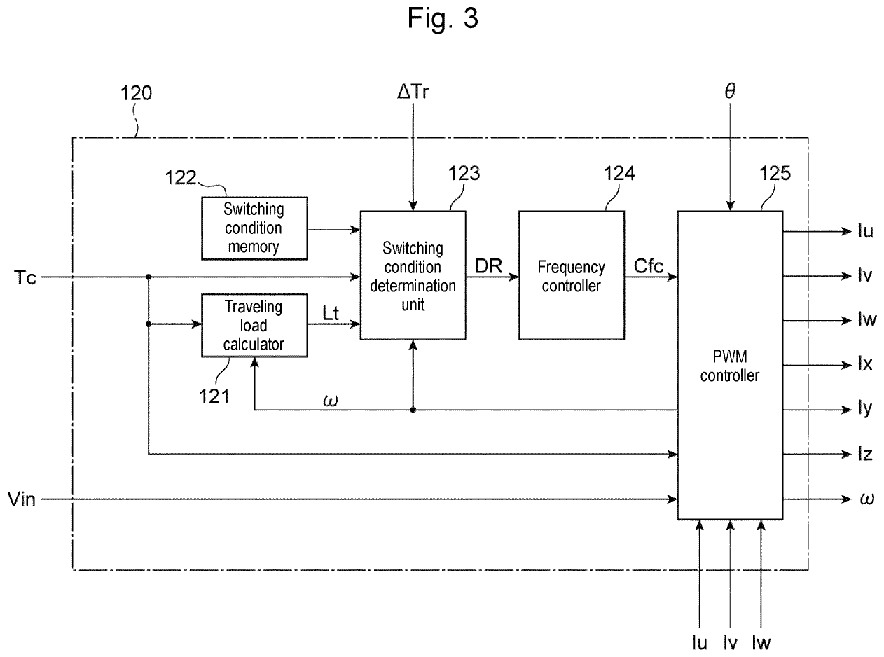

FIG. 3 is a block diagram of the three-phase current controller 120 constituting the electronic control device 100 of FIG. 1. For instance, the three-phase current controller 120 has a traveling load calculator 121, a switching condition memory 122, a switching condition determination unit 123, a frequency controller 124, and a pulse width modulation (PWM) controller 125.

For instance, the traveling load calculator 121 receives as input the torque commands Tc and rotation speeds ω of the electric motors 11, and estimates a traveling resistance value of the vehicle 10 due to a gradient. The traveling load calculator 121 further calculates the traveling load Lt of the vehicle 10 from this traveling resistance value, the weight of the vehicle 10, the rotation speeds ω of the electric motors 11, the frontal projected area of the vehicle 10, and others and outputs it to the switching condition determination unit 123.

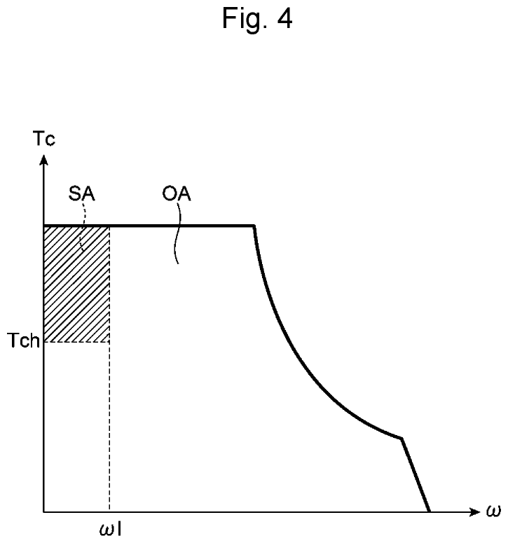

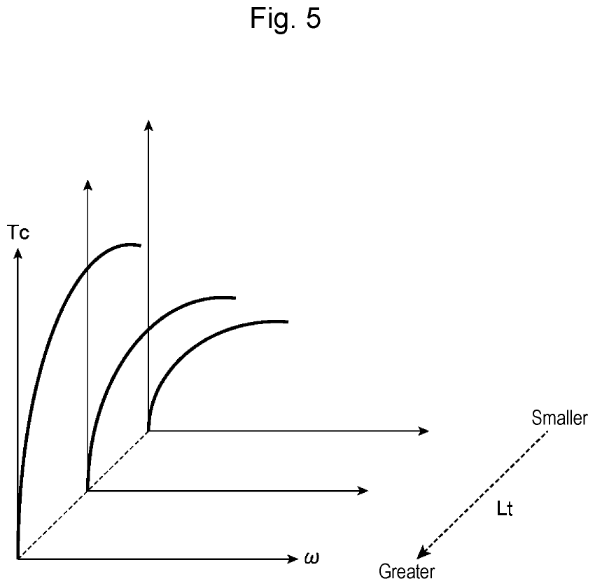

FIGS. 4 and 5 are graphs for explaining the switching condition memory 122, which is a part of the three-phase current controller 120 in FIG. 3. Specifically, the horizontal axis in the graph of FIG. 4 represents the rotation speed ω of the electric motor 11 and the vertical axis represents the torque command Tc of the motor 11. The graph shows the operating area OA and the switching area SA of the electric motor 11.

For instance, the switching area SA is an area where the rotation speed ω of the electric motor 11 is equal to or lower than a predetermined lower limit value ωl and the torque command Tc of the electric motor 11 is equal to or higher than a predetermined upper limit value Tch. In this switching area SA, the carrier frequency of the electric motor 11 needs to be lowered to protect the inverter 130. That is, the graph in FIG. 4 shows the switching condition that requires switching of the carrier frequency as the switching area SA.

However, switching the carrier frequency of the electric motor 11 while the relationship between the torque command Tc and the rotation speed ω of the electric motor 11 is in the switching area SA causes noise. Thus, switching of the carrier frequency of the electric motor 11 needs to be avoided in the switching area SA. In other words, the switching area SA is a restricted area where the switching of carrier frequency needs to be restricted from the viewpoint of suppressing noise of the electric motor 11.

The graph in FIG. 5 shows the relationship between the torque command Tc and the rotation speed ω of the electric motor 11 for different values of traveling load Lt, where the horizontal axis represents the rotation speed ω of the electric motor 11 and the vertical axis represents the torque command Tc of the electric motor 11. As shown in FIG. 5, the greater the traveling load Lt, the greater the change in torque command Tc relative to the change in rotation speed ω of the electric motor 11. The graphs in FIG. 4 and FIG. 5 are created for each electric motor 11. These graphs are then configured and recorded in the switching condition memory 122, and output from the switching condition memory 122 to the switching condition determination unit 123 as necessary.

For instance, the switching condition determination unit 123 receives as input the torque command Tc, the torque change rate limit ΔTr, and the rotation speed ω of each electric motor 11, as well as the traveling load Lt of the vehicle 10. For instance, the switching condition determination unit 123 acquires, from the switching condition memory 122, the operating area OA and switching area SA of each electric motor 11 shown in FIG. 4, and the relationship between the torque command Tc and rotation speed ω according to the traveling load Lt shown in FIG. 5. As described above, the switching area SA represents the switching condition that requires switching of the carrier frequency of the electric motors 11.

For instance, the switching condition determination unit 123 determines whether the relationship between the torque command Tc and rotation speed ω of each electric motor 11 is within the switching area SA after a predetermined period of time, on the basis of the above inputs, the switching area SA in FIG. 4, and the relationship in FIG. 5. Whether or not the relationship is within the switching area SA is synonymous with whether or not the switching condition that requires lowering the carrier frequency of the electric motor 11 is met. Specifically, the switching condition determination unit 123 overlaps the graphs of FIG. 4 and FIG. 5, for example. Then, if the Tc-ω curve in FIG. 5 is within or touches the switching area SA in FIG. 4, the switching condition determination unit 123 determines that the relationship between the torque command Tc and rotation speed ω of each electric motor 11 satisfies the switching condition after a predetermined time.

The switching condition determination unit 123 outputs to the frequency controller 124 the determination result DR about whether or not the relationship between the torque command Tc and the rotation speed ω of the electric motor 11 is within the switching area SA after a predetermined time elapses, that is, whether or not the switching condition (the rotation speed ω is lower than the lower limit ω1 and the torque command Tc is higher than the upper limit Tch) is satisfied.

For instance, on the basis of the determination result DR input from the switching condition determination unit 123, the frequency controller 124 outputs to the PWM controller 125 a control signal Cfc for lowering the carrier frequency of the electric motor 11 to be controlled. Specifically, the frequency controller 124 outputs this control signal Cfc when the determination result DR shows that the condition is satisfied, i.e., when it is determined that the relationship between the torque command Tc and rotation speed ω of the electric motor 11 to be controlled satisfies the switching condition after a predetermined time elapses.

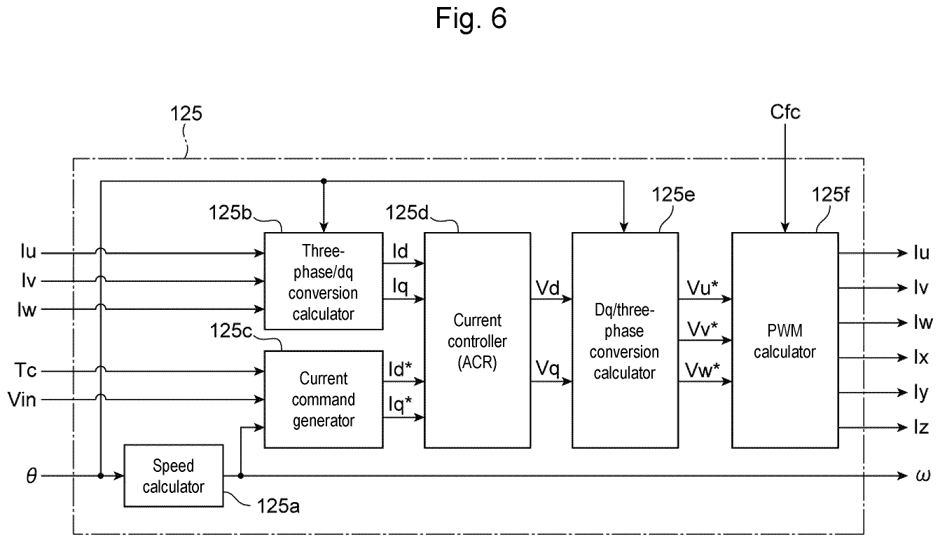

FIG. 6 is a block diagram of the PWM controller 125 that is a part of the three-phase current controller 120 of FIG. 3. The PWM controller 125 receives as input the three-phase currents Iu, Iv, Iw, rotation angle θ, and torque command Tc of each electric motor 11, the inverter voltage Vin, and a control signal Cfc of the frequency control unit 124, and outputs gate signals Iu, Iv, Iw, Ix, Iy, Iz and a rotation speed ω.

For instance, the PWM controller 125 includes a speed calculator 125a, a three-phase/dq conversion calculator 125b, a current command generator 125c, a current controller 125d, a dq/three-phase conversion calculator 125e, and a PMW calculator 125f. These sections of the PWM controller 125 have a typical configuration to vector control the electric motor 11, which is a permanent magnet motor, and thus a description thereof will be omitted. For instance, the PWM controller 125 lowers the carrier frequency of the power switching device in the inverter 130 on the basis of the control signal Cfc, which lowers the carrier frequency of each electric motor 11.

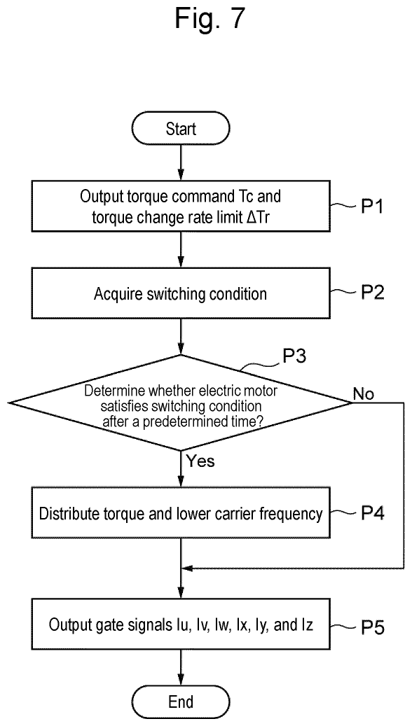

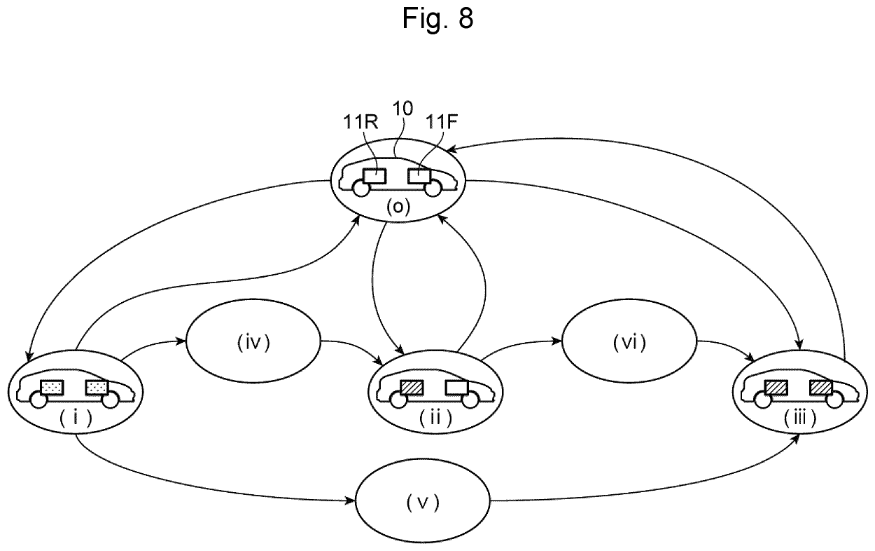

Hereinafter, the operation of the electronic control device 100 of this embodiment will be described with reference to FIGS. 7 through 14. FIG. 7 is a flowchart showing the operation of the electronic control device 100. FIG. 8 shows a state transition of the vehicle 10 under the control of the electronic control device 100.

A state (o) shown in FIG. 8 indicates the electronic control device 100 is not executing the control of the electric motors 11 (11F, 11R), such as a state in which the vehicle 10 stops. From this state (o), when the electronic control device 100 starts to control the electric motors 11 and the vehicle 10 starts traveling, for example. Then, the vehicle 10 transitions to a state (i) shown in FIG. 8, for example, and the electronic control device 100 executes process P1 shown in FIG. 7. The state (i) indicates the traveling load Lt of the vehicle 10 is low, and switching of the carrier frequency is not needed for the electric motors 11, for example.

For instance, in process P1 shown in FIG. 7, the torque controller 110 of the electronic control device 100 receives the accelerator pedal operation amount Qac, the acceleration a of the vehicle 10, and the control signals Sab, Stc of the ABS controller 16 and the TCS controller 17, as described above. On the basis of these inputs, the torque controller 110 outputs the torque command Tc and the torque change rate limit ΔTr to each of the three-phase current controllers 120 that control the electric motors 11, as described above.

Next, the electronic control device 100 executes process P2 to acquire a switching condition. For instance, in this process P2, the switching condition determination unit 123, which constitutes the three-phase current controller 120 of the electronic control device 100, acquires from the switching condition memory 122 the operating area OA and switching area SA of each electric motor 11 shown in FIG. 4 and the relationship between the torque command Tc and rotation speed ω according to the traveling load Lt shown in FIG. 5.

Next, the electronic control device 100 executes process P3 to determine whether the switching condition is satisfied. In this process P3, the switching condition determination unit 123 of the electronic control device 100 receives the torque command Tc, the torque change rate limit ΔTr, and the rotation speed ω of each electric motor 11, as well as the traveling load Lt of the vehicle 10, as described above. For instance, on the basis of these inputs and the graphs in FIGS. 4 and 5 obtained in the previous process P2, the switching condition determination unit 123 determines whether or not each electric motor 11 satisfies the switching condition after a predetermined time.

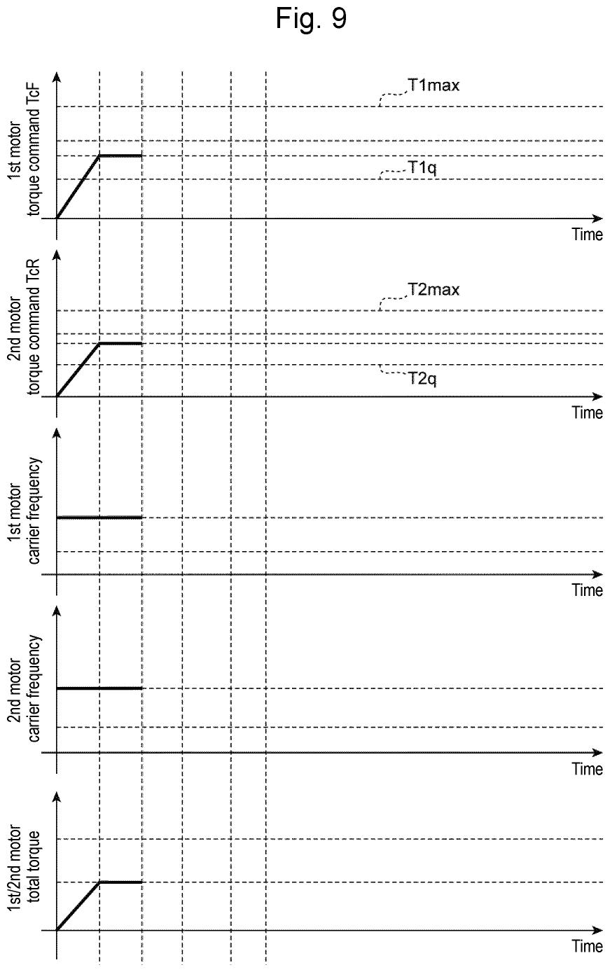

FIG. 9 are graphs showing an example of the torque commands Tc (TcF, TcR) of the electric motors 11, their carrier frequencies, and the total torque of all the electric motors 11 in the state (i) of the vehicle 10 in FIG. 8. The first and second graphs of the torque commands TcF and TcR from the top in FIG. 9 show the maximum torques T1max and T2max of the first electric motor 11F and the second electric motor 11R, respectively, and the torques T1q and T2q that sufficiently suppress noise when the carrier frequency is switched.

In this state (i) of the vehicle 10, the traveling load Lt is relatively small, so that as shown in FIG. 5, a change in the torque command Tc relative to a change in the rotation speed ω of each electric motor 11 is relatively small. As a result, the torque commands Tc (TcF, TcR) of the electric motors 11 after the predetermined time elapses are not within the switching area SA shown in FIG. 4, meaning that the switching condition is not satisfied after the predetermined time elapses.

In this case, in the process P3 shown in FIG. 7, the switching condition determination unit 123 determines that the switching condition is not satisfied (NO) after a predetermined time, and the electronic control device 100 executes process P5 without executing process P4 described later. In process P5, the PWM controller 125f that constitutes the PWM controller 125 of the three-phase current controller 120 outputs gate signals Iu, Iv, Iw, Ix, Iy, and Iz in accordance with the control signal Cfc that lowers the carrier frequency and the command voltages Vu*, Vv*, and Vw*.

The torque controller 110 may distribute the torque between the first electric motor 11F and the second electric motor 11R so that the relationship between the torque commands TcF, TcR and the rotation speeds @F, OR of the first electric motor 11F and the second electric motor 11R does not fall within the switching area SA shown in FIG. 4.

The same applies when the vehicle 10 has four or more electric motors 11. That is, the torque controller 110 may appropriately distribute the torque among the multiple electric motors 11 so that the relationship between the torque command Tc and the rotation speed ω does not fall within the switching are SA and thus switching of the carrier frequency is not needed. In this process P5, the torque controller 110 does not change the torque change rate limit ΔTr, for example.

Each of the inverters 130 outputs three-phase currents Iu, Iv, Iw to the corresponding electric motor 11 on the basis of the input gate signals Iu, Iv, Iw, Ix, Iy, Iz. This causes the electric motors 11 to rotate, thus rotating the right and left front wheels 13F and left and right rear wheels 13R via the gears 12F and 12R to drive the vehicle 10. Thereafter, the electronic control device 100 ends the process shown in FIG. 7, for example, and executes the process repeatedly at a predetermined cycle.

If the traveling load Lt increases because the vehicle 10 goes uphill immediately after it starts driving, for example, the state of vehicle 10 transitions from state (o) to state (ii) shown in FIG. 8. The state (ii) indicates the traveling load Lt of the vehicle 10 is higher than in the state (i), and switching of the carrier frequency is needed for some of the electric motors 11 to protect the inverter 130.

For instance, for the electronic control device 100 of this embodiment, the state (ii) requires switching the carrier frequency of the second electric motor 11R between the first electric motor 11F that drives the front wheels 13F and the second electric motor 11R that drives the rear wheels 13R. If the electronic control device 100 executes the aforementioned process P3 in this state (ii), the increase of the traveling load Lt of the vehicle 10 causes a change in torque command Tc (TcR) relative to a change in rotation speed ω (ωR) of the second electric motor 11R to increase more than in the state (i), as shown in FIG. 5, for example.

As a result, the switching condition determination unit 123 determines in process P3 that the relationship between the torque command TcR and the rotation speed ωR of the second electric motor 11R enters the switching area SA shown in FIG. 4 after a predetermined time elapses and that the switching condition is satisfied (YES). The switching condition determination unit 123 also determines in process P3 that the relationship between the torque command TcF and the rotation speed ωF of the first electric motor 11F does not enter the switching area SA shown in FIG. 4 after a predetermined time elapses and that the switching condition is not satisfied (NO). Thereafter, the frequency controller 124 outputs the determination result DR of the process P3 to the PWM controller 125.

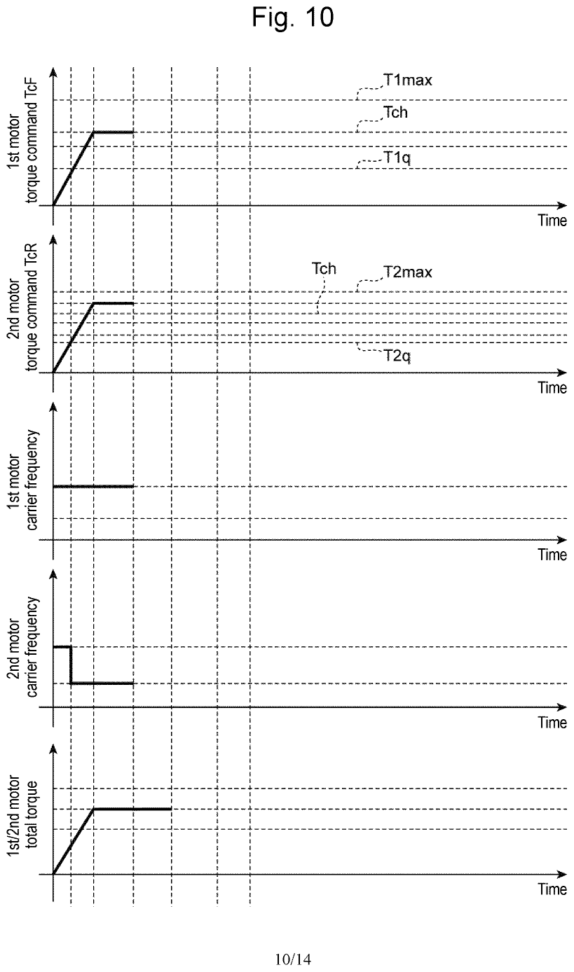

In process P3, if it is determined that the switching condition is satisfied (YES) after a predetermined time for at least one electric motor 11, for example, then the electronic control device 100 executes the following process P4. In this process P4, the electronic control device 100 distributes the torque of the multiple electric motors 11, and lowers the carrier frequency of the electric motor 11 that is determined to satisfy the switching condition after a predetermined time elapses. FIG. 10 are graphs showing an example of the torque commands Tc (TcF, TcR) of the electric motors 11, their carrier frequencies, and the total torque of all the electric motors 11 (11F, 11R) in the state (ii) of the vehicle 10 in FIG. 8. The first and second graphs of the torque commands TcF and TcR from the top in FIG. 10 show the torques T1q and T2q that sufficiently suppress noise when the carrier frequency is switched.

In process P4, the second three-phase current controller 120R that controls the second electric motor 11R, for example, in the electronic control device 100 outputs a control signal Cfc that lowers the carrier frequency from the frequency controller 124 to the PWM controller 125. In this process, the frequency controller 124 outputs the control signal Cfc to the PWM controller 125 before the torque command TcR of the second electric motor 11R exceeds a torque T2q that sufficiently suppresses noise generated when the carrier frequency is switched, for example.

As a result, as shown in the second graph from the top and the second graph from the bottom in FIG. 10, the carrier frequency of the second electric motor 11R drops to a predetermined frequency capable of protecting the inverter 130 before the torque command TcR of the second electric motor 11R exceeds the torque T2q. This sufficiently suppresses the noise generated when lowering the carrier frequency of the second electric motor 11R that drives the rear wheels 13R of the vehicle 10.

Before the curve showing the relationship between the torque command TcR and the rotation speed ωR of the second electric motor 11R enters the switching area SA, that is, when the torque command TcR of the second electric motor 11R is equal to or lower than the upper limit Tch, lowering the carrier frequency of the second electric motor 11R allows a noise suppression effect to be obtained.

Furthermore, in process P4 shown in FIG. 7, the electronic control device 100 distributes torque to the plurality of electric motors 11 by the torque controller 110, for example. Specifically, the torque command generator 114 shown in FIG. 2 distributes torque commands TcF and TeR to the first electric motor 11F and the second electric motor 11R to the extent that switching the carrier frequency of the first electric motor 11F is not needed.

The first and second graphs of the torque commands TcF and TeR from the top in FIG. 10 show the maximum torque T1max and T2max of the first electric motor 11F and the second electric motor 11R, respectively, and their upper limits Tch of the torque commands TcF and TcR. These upper limits Tch are values, at which the curves indicating the relationship between the torque command Tc and the rotation speed ω of each of the first electric motor 11F and the second electric motor 11R shown in FIG. 5 do not enter the switching area SA shown in FIG. 4.

In this process P4, the torque controller 110 distributes the torque between the first electric motor 11F and the second electric motor 11R so that the torque command TcF of the first electric motor 11F that drives the front wheels 13F of the vehicle 10 does not fall within the switching area SA shown in FIG. 4, for example. Specifically, the torque controller 110 limits the torque command TcF of the first electric motor 11F whose carrier frequency is not lowered to the upper limit Tch or less.

The torque controller 110 increases the torque command TcR of the second electric motor 11R, the carrier frequency of which has been reduced, beyond the upper limit Tch, but within a range not exceeding the maximum torque T2max. In this process P4, the torque controller 110 reduces the torque change rate limit ΔTrR of the second electric motor 11R, for example, and does not change the torque change rate limit ΔTrF of the first electric motor 11F.

Thereafter, the electronic control device 100 executes the aforementioned process P5, for example, to end the process shown in FIG. 7. This supplements the torque shortage, which is caused by limiting the torque command TcF of the first electric motor 11F below the upper limit Tch, with the torque of the second electric motor 11R, thus allowing the desired total torque to be output by the first electric motor 11F and second electric motor 11R.

When the vehicle 10 travels on a steep uphill and thus the traveling load Lt increases significantly or due to rapid acceleration, the state of the vehicle 10 transitions from state (o) to state (iii) shown in FIG. 8, for example. The state (iii) indicates the traveling load Lt of the vehicle 10 is higher than in the state (ii), and switching of the carrier frequency is needed for all the electric motors 11 to protect the inverters 130.

For instance, for the electronic control device 100 of this embodiment, the state (iii) requires switching the carrier frequencies of both of the first electric motor 11F that drives the front wheels 13F and of the second electric motor 11R that drives the rear wheels 13R. If the electronic control device 100 executes the aforementioned process P3 in this state (iii), the increase of the traveling load Lt of the vehicle 10 causes a change in torque command Tc (TcF, TcR) relative to a change in rotation speed ω (ωF, ωR) of the first electric motor 11F and second electric motor 11R to increase more than in the state (ii), as shown in FIG. 5, for example.

As a result, the switching condition determination unit 123 determines in process P3 that the relationship between the torque command TcF, TcR and the rotation speed ωF, ωR of the first electric motor 11F and second electric motor 11R enters the switching area SA shown in FIG. 4 after a predetermined time elapses and that the switching condition is satisfied (YES). Thereafter, the frequency controller 124 outputs this determination result DR to the PWM controller 125.

Thereafter, the electronic control device 100 executes the next process P4, for example. In this process P4, the electronic control device 100 lowers the carrier frequencies of both the first electric motor 11F and the second electric motor 11R, which are determined to satisfy the switching condition after a predetermined time elapses, and distributes torque between the first electric motor 11F and the second electric motor 11R, for example.

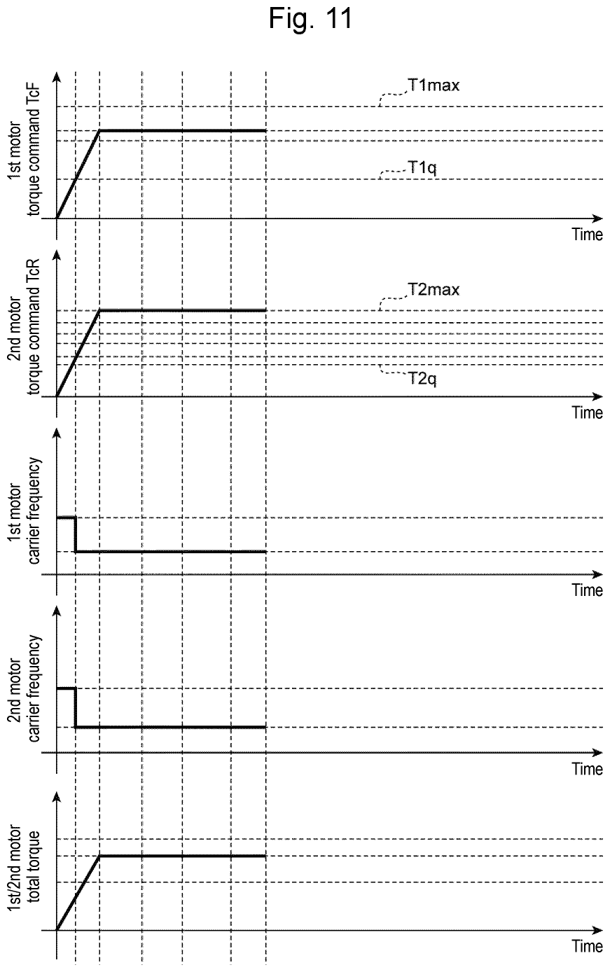

FIG. 11 are graphs showing an example of the torque commands Tc (TcF, TcR) of the electric motors 11, their carrier frequencies, and the total torque of all the electric motors 11 (11F, 11R) in the state (iii) of FIG. 8. The first and second graphs of the torque commands TcF and TcR from the top in FIG. 11 show the torques T1q and T2q that sufficiently suppress noise when the carrier frequency is switched.

In process P4, the three-phase current controllers 120 that control the first electric motor 11F and the second electric motor 11R, for example, in the electronic control device 100 output a control signal Cfc that lowers their carrier frequencies from the frequency controller 124 to the PWM controller 125. In this process, the frequency controller 124 of each three-phase current controller 120 outputs the control signal Cfc to the PWM controller 125 before the torque commands TcF and TcR of the first electric motor 11F and the second electric motor 11R exceed their torque T2q and T2q that sufficiently suppress noise generated when the carrier frequency is switched, for example.

As a result, as shown in FIG. 11, the carrier frequencies of the first electric motor 11F and the second electric motor 11R drop to a predetermined frequency capable of protecting the inverters 130 before the torque commands TcF and TeR of the first electric motor 11F and the second electric motor 11R exceed the torques T1q and T2q, respectively. This sufficiently suppresses the noise generated when lowering the carrier frequencies of the first electric motor 11F and the second electric motor 11R of the vehicle 10.

Before the torque command of the first electric motor 11F and the torque command TcR of the second electric motor 11R exceed the upper limit Tch and enter the switching area SA, that is, when the switching condition is satisfied, the carrier frequencies of the first electric motor 11F and the second electric motor 11R are lowered. This allows a noise suppression effect to be obtained. Furthermore, in this process P4, the electronic control device 100 distributes torque to the first electric motor 11F and the second electric motor 11R by the torque controller 110 as needed, for example.

Thereafter, the electronic control device 100 executes the aforementioned process P5, for example, to end the process shown in FIG. 7. As described above, in state (iii) of the vehicle 10, the electronic control device 100 lowers the carrier frequencies of the first electric motor 11F and the second electric motor 11R before the torque commands TcF and TeR exceed the torques Tq1 and Tq2 or the upper limit Tch that does not enter the switching area SA. This suppresses the noise generated when lowering the carrier frequencies of the first electric motor 11F and the second electric motor 11R of the vehicle 10.

As shown in FIG. 8, in the state (i), the traveling load Lt of the vehicle 10 is low and there is no need to lower the carrier frequency of all the electric motors 11. In this state, the state transitions to the aforementioned state (ii) via state (iv) due to an increase in the traveling load Lt of the vehicle 10, for example. The state (iv) indicates the traveling load Lt of the vehicle 10 is higher than in the state (i), and switching of the carrier frequency is needed for some of the electric motors 11 to protect the inverter 130.

For instance, for the electronic control device 100 of this embodiment, the state (iv) requires switching the carrier frequency of the second electric motor 11R between the first electric motor 11F that drives the front wheels 13F and the second electric motor 11R that drives the rear wheels 13R. If the electronic control device 100 executes the aforementioned process P3 in this state (iv), the switching condition determination unit 123 determines that the relationship between the torque command TcR and the rotation speed @R of the second electric motor 11R enters the switching area SA shown in FIG. 4 after a predetermined time elapses and the switching conditions are satisfied (YES). Thereafter, the frequency controller 124 outputs this determination result DR to the PWM controller 125.

Thereafter, the electronic control device 100 executes the next process P4, for example. In this process P4, the electronic control device 100 first distributes torque between the first electric motor 11F and the second electric motor 11R, and then lowers the carrier frequency of the second electric motor 11R.

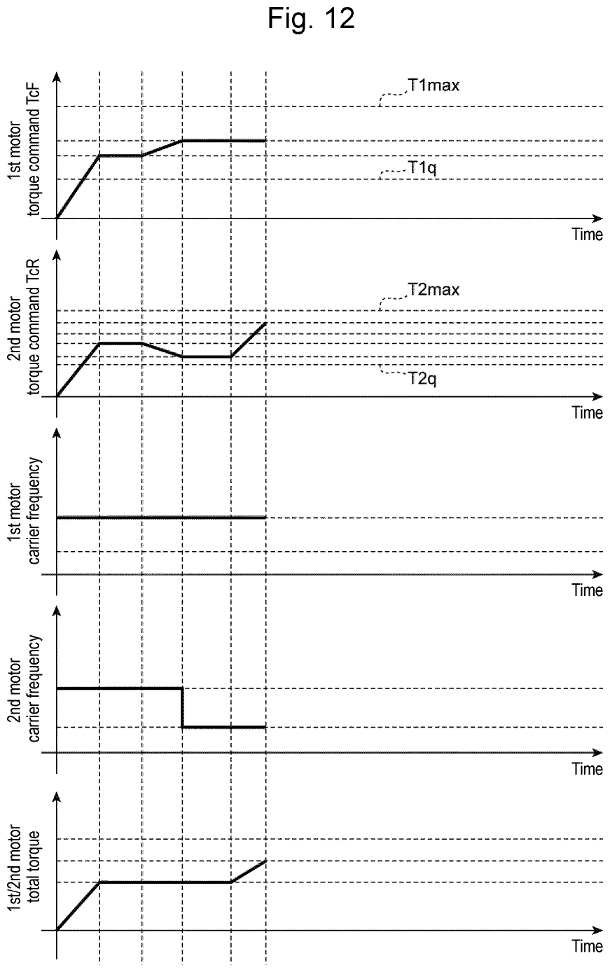

FIG. 12 are graphs showing an example of the torque commands Tc (TcF, TcR) of the electric motors 11, their carrier frequencies, and the total torque of all the electric motors 11 (11F, 11R) in the state (iv) of FIG. 8. In process P4, the torque controller 110 reduces the torque command TcR of the second electric motor 11R and increases the torque command TcF of the first electric motor 11F before the frequency controller 124 lowers the carrier frequency of the second electric motor 11R, thereby maintaining the total torque at a constant value. At this time, the torque controller 110 increases the torque change rate limits ΔTrF and ΔTrR of the first electric motor 11F and the second electric motor 11R, for example.

Thereafter, when the torque command TcR of the second electric motor 11R decreases to a predetermined value capable of suppressing noise caused by switching of the carrier frequency, the frequency controller 124 outputs a control signal Cfc to the PWM controller 125 to lower the carrier frequency of the second electric motor 11R. This suppresses noise caused by switching the carrier frequency of the second electric motor 11R.

For instance, the torque controller 110 reduces the torque change rate limit ΔTrR at the timing to switch the carrier frequency of the second electric motor 11R. After the frequency controller 124 lowers the carrier frequency of the second electric motor 11R, for example, the torque controller 110 increases the torque command TcR of the second electric motor 11R and limits the torque command TcF of the first electric motor 11F below the upper limit Tch that enters the switching area SA. This eliminates the need to switch the carrier frequency of the first electric motor 11F and prevents noise generation when the carrier frequency is switched at high torque.

As shown in FIG. 8, in the state (i), the traveling load Lt of the vehicle 10 is low and there is no need to lower the carrier frequency of all the electric motors 11. In this state, the state transitions to the aforementioned state (iii) via state (v) due to a sudden increase in the traveling load Lt of the vehicle 10, for example. The state (v) indicates the traveling load Lt of the vehicle 10 is higher than in the state (ii), and switching of the carrier frequency is needed for all the electric motors 11 to protect the inverters 130.

If the electronic control device 100 executes the aforementioned process P3 in this state (v), the switching condition determination unit 123 determines that the relationship between the torque commands TcF, TcR and the rotation speeds ωF, ωR of the first electric motor 11F and the second electric motor 11R enters the switching area SA shown in FIG. 4 after a predetermined time elapses and the switching condition is satisfied (YES). The switching condition determination unit 123 outputs this determination result DR to the frequency controller 124.

Thereafter, the electronic control device 100 executes the next process P4, for example. In this process P4, the electronic control device 100 first lowers the carrier frequency of the second electric motor 11R, and then distributes torque between the first electric motor 11F and the second electric motor 11R. Thereafter, the electronic control device 100 lowers the carrier frequency of the first electric motor 11F.

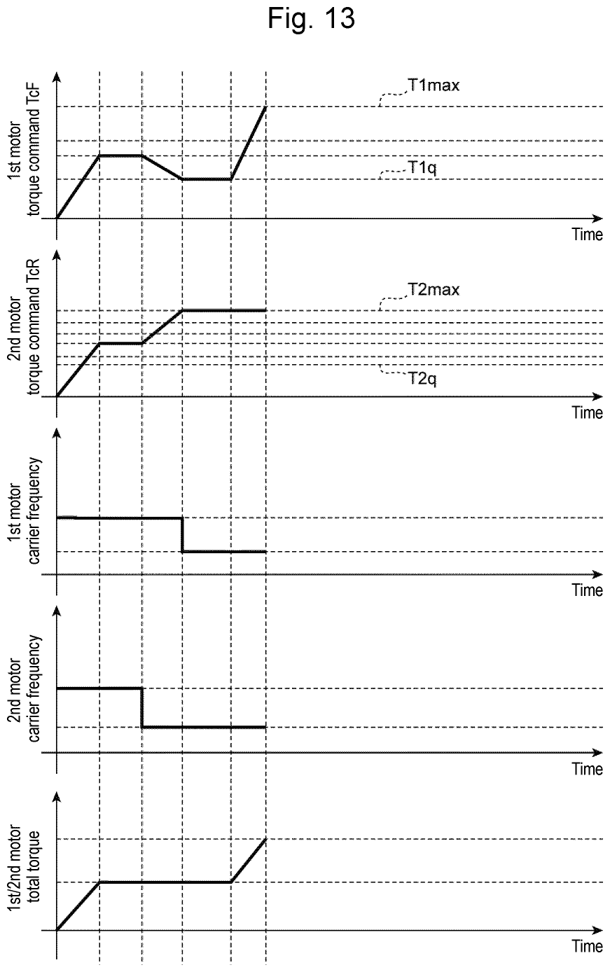

FIG. 13 are graphs showing an example of the torque commands Tc (TcF, TcR) of the electric motors 11, their carrier frequencies, and the total torque of all the electric motors 11 (11F, 11R) in the state (v) of FIG. 8. In process P4, the frequency controller 124 outputs a control signal Cfc to the PWM controller 125 to lower the carrier frequency of the second electric motor 11R before the relationship between the torque command TcR and the rotation speed ωR of the second motor 11R enters the switching area SA shown in FIG. 4 and the switching condition is satisfied.

Thereafter, in this process P4, the torque controller 110 decreases the torque command TcF of the first electric motor 11F and increases the torque command TcR of the second electric motor 11R, thereby maintaining the total torque at a constant value. At this time, the torque controller 110 increases the torque change rate limits ΔTrF and ΔTrR of the first electric motor 11F and the second electric motor 11R, for example.

Thereafter, when the torque command TcF of the first electric motor 11F decreases to torque T1q capable of suppressing noise caused by switching of the carrier frequency, the frequency controller 124 outputs a control signal Cfc to the PWM controller 125 to lower the carrier frequency of the first electric motor 11F. This suppresses noise caused by switching the carrier frequency of the first electric motor 11F.

For instance, the torque controller 110 reduces the torque change rate limit ΔTrF at the timing to switch the carrier frequency of the first electric motor 11F. After lowering the carrier frequency of the first electric motor 11F, for example, the torque controller 110 increases the torque command TcF to the maximum torque Tlmax and keeps the torque command TcR of the second electric motor 11R at the maximum torque T2max.

As shown in FIG. 8, in the state (ii), the carrier frequency of some of the electric motors 11 of the vehicle 10 needs to be lowered. In this state, the state transitions to the aforementioned state (iii) via state (vi) due to a further increase in the traveling load Lt of the vehicle 10, for example. The state (vi) indicates the traveling load Lt of the vehicle 10 is higher than in the state (ii), and switching of the carrier frequency is needed for all the electric motors 11 to protect the inverters 130.

If the electronic control device 100 executes the aforementioned process P3 in this state (vi), the switching condition determination unit 123 determines that the relationship between the torque commands TcF, TcR and the rotation speeds ωF, WR of the first electric motor 11F and the second electric motor 11R enters the switching area SA shown in FIG. 4 after a predetermined time elapses and the switching condition is satisfied (YES). Thereafter, the frequency controller 124 outputs this determination result DR to the PWM controller 125.

Thereafter, the electronic control device 100 executes the next process P4, for example. In this process P4, the electronic control device 100 first lowers the carrier frequency of the second electric motor 11R, and then distributes torque between the first electric motor 11F and the second electric motor 11R. Thereafter, the electronic control device 100 lowers the carrier frequency of the first electric motor 11F.

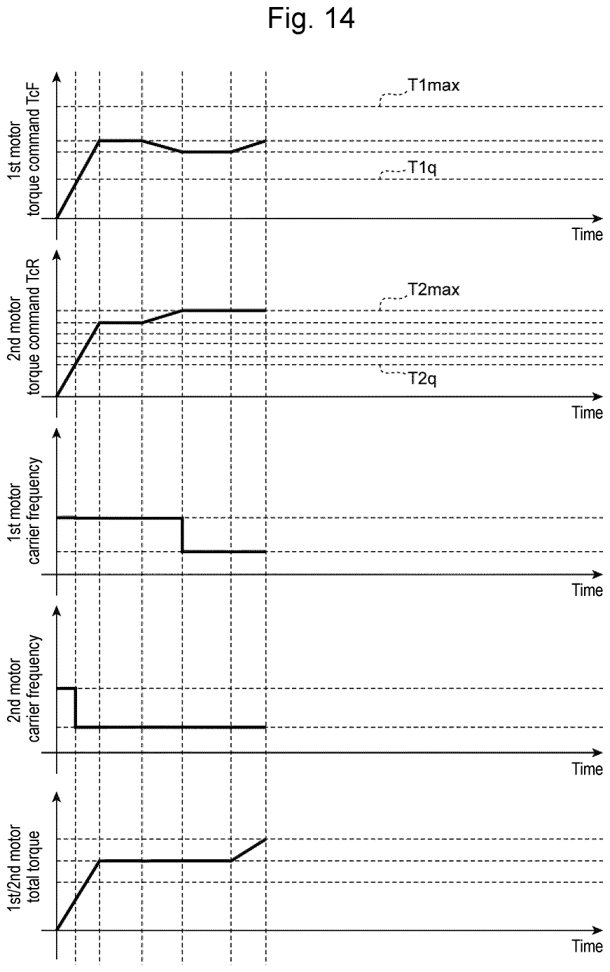

FIG. 14 are graphs showing an example of the torque commands Tc (TcF, TcR) of the electric motors 11, their carrier frequencies, and the total torque of all the electric motors 11 (11F, 11R) in the state (vi) of FIG. 8. In process P4, the frequency controller 124 outputs a control signal Cfc to the PWM controller 125 to lower the carrier frequency of the second electric motor 11R before the relationship between the torque command TcR and the rotation speed @R of the second motor 11R enters the switching area SA shown in FIG. 4 and the switching condition is satisfied.

Specifically, the frequency controller 124 outputs the control signal Cfc to the PWM controller 125, thus lowering the carrier frequency of the second electric motor 11R, before the torque command TcR of the second electric motor 11R exceeds a torque T2q that sufficiently suppresses noise generated when the carrier frequency is switched, for example. This suppresses noise caused by switching the carrier frequency of the second electric motor 11R more reliably.

Thereafter, in this process P4, the torque controller 110 decreases the torque command TcF of the first electric motor 11F and increases the torque command TcR of the second electric motor 11R, thereby maintaining the total torque at a constant value. At this time, the torque controller 110 increases the torque change rate limits ΔTrF and ΔTrR of the first electric motor 11F and the second electric motor 11R, for example.

Thereafter, when the torque command TcF of the first electric motor 11F decreases to a predetermined value capable of suppressing noise caused by switching of the carrier frequency, the electronic control device 100 outputs a control signal Cfc from the frequency controller 124 to the PWM controller 125 to lower the carrier frequency of the first electric motor 11F. This suppresses noise caused by switching the carrier frequency of the first electric motor 11F.

For instance, the torque controller 110 reduces the torque change rate limit ΔTrF at the timing to switch the carrier frequency of the first electric motor 11F. After lowering the carrier frequency of the first electric motor 11F, for example, the torque controller 110 increases the torque command TcF, and limits the torque command TcR of the second electric motor 11R below the maximum torque T2max.

As described above, the electronic control device 100 of this embodiment has the switching condition memory 122, the traveling load calculator 121, the switching condition determination unit 123, and the frequency controller 124 to control the electric motors 11 for driving the vehicle 10. The switching condition memory 122 stores the switching area SA that is a switching condition where the rotation speed ω of the electric motor 11 is lower than the predetermined lower limit ω1 and the torque command Tc of the electric motor 11 is higher than the predetermined upper limit Tch. The traveling load calculator 121 calculates the traveling load Lt of the vehicle 10 on the basis of the rotation speed ω and the torque command Tc of the electric motor 11. The switching condition determination unit 123 determines whether or not a switching condition is satisfied after a predetermined time, on the basis of the traveling load Lt of the vehicle 10, and the rotation speed ω and torque command Tc of the electric motor 11. If the switching condition determination unit 123 determines that the switching condition is satisfied, the frequency controller 124 lowers the carrier frequency of the electric motor 11 when the torque command Tc of the electric motor 11 is equal to or lower than the upper limit Tch.

With this configuration, the electronic control device 100 of this embodiment is capable of suppressing noise of the electric motor 11 when the carrier frequency is switched. Specifically, the electronic control device 100 of this embodiment is configured so that the switching condition determination unit 123 determines whether the electric motor 11 satisfies the switching condition after a predetermined time elapses. This switching condition corresponds to the switching area SA shown in FIG. 4, where the rotation speed ω of the electric motor 11 is lower than the predetermined lower limit ω1 and the torque command Tc of the motor 11 is greater than the predetermined upper limit Tch, and where the carrier frequency of the motor 11 needs to be lowered. However, if the carrier frequency is lowered after the electric motor 11 satisfies the switching condition, the carrier frequency will be switched while the torque command Tc of the motor 11 is high, which may cause noise. To avoid this, the electronic control device 100 of this embodiment is configured so that, if the switching condition determination unit 123 determines that the switching condition is satisfied after a predetermined time elapses, then the frequency controller 124 lowers the carrier frequency of the electric motor 11 when the torque command Tc of the electric motor 11 is equal to or less than the predetermined upper limit Tch, that is, before the switching condition is satisfied. This allows the carrier frequency of the electric motor 11 to be lowered at a lower torque command Tc than when the carrier frequency is lowered after the electric motor 11 satisfies the switching condition, thereby reducing noise due to the carrier frequency switching.

In the electronic control device 100 of the present embodiment, the electric motor 11 includes at least the first electric motor 11F and the second electric motor 11R. The switching condition determination unit 123 determines whether or not the switching condition is satisfied for each of the first electric motor 11F and the second electric motor 11R. Then, if the switching condition determination unit 123 determines that at least one of the first electric motor 11F and the second electric motor 11R satisfies the switching condition after a predetermined time elapses, the frequency controller 124 lowers the carrier frequency of the electric motor before the switching condition is satisfied.

With this configuration, when the torque command TcF, TcR of at least one of the first electric motor 11F and the second electric motor 11R is equal to or lower than a predetermined upper limit Tch, the electronic control device 100 of this embodiment is capable of lowering the carrier frequency of the electric motor 11. Thus, compared to the case where the carrier frequency is switched when the torque command Tc of that motor 11 is higher than the upper limit Tch, this embodiment suppresses noise during carrier frequency switching.

The electronic control device 100 of the present embodiment includes the torque controller 110 that outputs the torque commands TcF and TeR to the first electric motor 11F and the second electric motor 11R, respectively. For instance, as shown in FIG. 12, for example, the torque controller 110 increases the torque command Tc to be output to one of the first electric motor 11F and the second electric motor 11R, which is not a target of switching of the carrier frequency because the switching condition is determined not to be satisfied by the switching condition determination unit 123, within a range not exceeding the predetermined upper limit Tch. The torque controller 110 decreases the torque command Tc to be output to the other of the first electric motor 11F and the second electric motor 11R, which is a target of switching of the carrier frequency because the switching condition is determined to be satisfied by the switching condition determination unit 123, to a predetermined value. When the torque controller 110 decreases the torque command Tc output to the electric motor 11, which is the switching target, to the predetermined value, the frequency controller 124 lowers the carrier frequency of the electric motor 11 as the switching target.

With this configuration, the electronic control device 100 of this embodiment prevents the electric motor 11, which is not a target of carrier frequency switching, from satisfying the switching condition. Thus, the present embodiment suppresses noise due to carrier frequency switching of the electric motor 11, which is not a target of carrier frequency switching. The present embodiment lowers the torque command Tc to be output to the electric motor 11, which is a target of carrier frequency switching, to a predetermined value, and then lowers the carrier frequency of the electric motor 11 as the switching target. Thus, the present embodiment suppresses noise due to carrier frequency switching of the electric motor 11, which is a target of carrier frequency switching, at high torque.

In the electronic control device 100 of this embodiment, as shown in FIG. 12, for example, the torque controller 110 decreases the torque command Tc to be output to the electric motor 11 as a switching target to a predetermined value. Thereafter, the torque controller 110 may increase the torque command Tc to be output to the electric motor 11 as the switching target when the torque command Tc to be output to the electric motor 11 that is not a switching target reaches the predetermined upper limit Tch.

With this configuration, the electronic control device 100 of this embodiment decreases the torque command Tc output to the electric motor 11, which is a target of the carrier frequency switching, to a predetermined value, thereby reducing noise generated when the carrier frequency is switched. The electronic control device 100 of the present embodiment keeps the torque command Tc of the electric motor 11 that is not a switching target to be equal to or lower than the upper limit Tch, thereby preventing the need to switch the carrier frequency. Such a configuration of suppressing the torque command Tc of the electric motor 11 that is not a switching target may lead to torque shortage. The present embodiment supplements this shortage with an increase of the torque command Tc of the electric motor 11 after switching the carrier frequency.

The electronic control device 100 of the present embodiment includes the torque controller 110 that outputs the torque commands TcF and TeR to the first electric motor 11F and the second electric motor 11R, respectively. If the switching condition determination unit 123 determines that the first electric motor 11F and the second electric motor 11R satisfy the switching conditions after a predetermined time, as shown in FIG. 13 and FIG. 14, the frequency controller 124 lowers the carrier frequency of one of the first electric motor 11F and the second electric motor 11R before the one of the electric motors 11 satisfies the switching conditions. After the frequency controller 124 lowers the carrier frequency of the one of the electric motors 11, the torque controller 110 increases the torque command Tc of the one of the electric motors 11 and decreases the torque command Tc of the other of the first electric motor 11F and the second electric motor 11R to a predetermined value. When the torque controller 110 decreases the torque command Tc of the other of the electric motors 11 to the predetermined value, the frequency controller 124 lowers the carrier frequency of the other electric motor 11.

With this configuration, the electronic control device 100 of the present embodiment changes the carrier frequency of the one electric motor 11 when the torque command Tc of that electric motor 11 is lower than the upper limit Tch, thus suppressing noise. The electronic control device 100 also decreases the torque command Tc of the other electric motor 11 to the predetermined value, and then lowers the carrier frequency of that electric motor 11, thus suppressing noise. In addition, when decreasing the torque command Tc of the other electric motor 11, the electronic control device 100 increases the torque command Tc of the one of the electric motors 11 whose carrier frequency has been switched, thus suppressing a decrease in the total torque.

In the electronic control device 100 of this embodiment, the torque controller 110 decreases the torque command Tc of the other electric motor 11 to the predetermined value. Thereafter, when the relationship between the torque command Tc and the rotation speed ω of the one electric motor 11 reaches the upper limit of the operation range of the one electric motor 11, the torque controller 110 increases the torque command Tc of the other electric motor 11.

With this configuration, the electronic control device 100 of the present embodiment distributes torque between the first electric motor 11F and the second electric motor 11R, and changes the carrier frequency if the torque command Te is lower than the upper limit Tch, thus suppressing noise. The present embodiment distributes torque between the first and second electric motors 11F and 11R to prevent the total torque from decreasing.

That is a detailed description of the embodiments of the electronic control device according to the present disclosure, with reference to the drawings. The specific configuration of the present disclosure is not limited to the above-stated embodiments, and the design may be modified variously without departing from the spirits of the present disclosure. The present disclosure also covers such modified embodiments. For instance, the above embodiment describes an example in which the electronic control device preferentially performs switching of the carrier frequency of the second electric motor that is away from the driver's seat of the vehicle, and thus suppresses switching of the carrier frequency of the first electric motor close to the driver's seat. However, the electronic control device in another embodiment may preferentially switch the carrier frequency of the first electric motor that is closer to the driver's seat of the vehicle. The electronic control device may also include a machine learning unit that learns the driving tendencies of the driver of the vehicle and updates the information stored in the switching condition memory.

### REFERENCE SIGNS LIST

10 Vehicle
11 Electric motor
11F 1st electric motor
11R 2nd electric motor
100 Electronic control device
110 Torque controller
121 Traveling load calculator
122 Switching condition memory
123 Switching condition determination unit
124 Frequency controller
Lt Traveling load
Tc Torque command
TcF Torque command
Tch Upper limit
TcR Torque command
ω Rotation speed
ωF Rotation speed
ω1 Lower limit
ωR Rotation speed

1. An electronic control device that controls at least one electric motor for driving a vehicle, comprising:
a switching condition memory that stores a switching condition that a rotation speed of the at least one electric motor is lower than a predetermined lower limit and a torque command of the at least one electric motor is higher than a predetermined upper limit;
a traveling load calculator that is configured to calculate a traveling load of the vehicle on a basis of a rotation speed and a torque command of the at least one electric motor;
a switching condition determination unit that is configured to determine whether the at least one electric motor satisfies the switching condition after a predetermined time elapses, on the basis of the traveling load of the vehicle and the rotation speed and the torque command of the at least one electric motor; and
a frequency controller that is configured to lower a carrier frequency of the at least one electric motor in response to a determination by the switching condition determination unit that the switching condition is satisfied, when the torque command of the at least one electric motor is equal to or lower than the upper limit.

2. The electronic control device according to claim 1, wherein the at least one electric motor includes at least a first electric motor and a second electric motor,
the switching condition determination unit is configured to determine whether or not the switching condition is satisfied for each of the first electric motor and the second electric motor, and
in response to a determination by the switching condition determination unit that at least one of the first electric motor and the second electric motor satisfies the switching condition after a predetermined time elapses, the frequency controller lowers a carrier frequency of the determined electric motor before the switching condition is satisfied.

3. The electronic control device according to claim 2, further comprising a torque controller that is configured to output a torque command to each of the first electric motor and the second electric motor, and
the torque controller increases a torque command to be output to one of the first electric motor and the second electric motor, which is not a target of switching of a carrier frequency because the switching condition is determined not to be satisfied by the switching condition determination unit, within a range equal to or less than the upper limit, and decreases a torque command to be output to the other of the first electric motor and the second electric motor, which is a target of switching of the carrier frequency because the switching condition is determined to be satisfied by the switching condition determination unit, to a predetermined value, and
when the torque controller decreases the torque command to be output to the electric motor, which is the switching target, to the predetermined value, the frequency controller lowers a carrier frequency of the electric motor as the switching target.

4. The electronic control device according to claim 3, wherein after decreasing the torque command to be output to the electric motor as the switching target to the predetermined value, the torque controller increases the torque command to be output to the electric motor as the switching target when the torque command to be output to the electric motor that is not a switching target reaches the predetermined upper limit.

5. The electronic control device according to claim 2, further comprising a torque controller that is configured to output a torque command to each of the first electric motor and the second electric motor,
in response to a determination by the switching condition determination unit that the first electric motor and the second electric motor satisfy the switching condition after a predetermined time elapses, the frequency controller lowers a carrier frequency of one of the first electric motor and the second electric motor before the one electric motor satisfies the switching condition,
after the frequency controller lowers the carrier frequency of the one electric motor, the torque controller increases a torque command of the one electric motor and decreases a torque command of the other of the first electric motor and the second electric motor to a predetermined value, and
when the torque controller decreases the torque command to the other electric motor to the predetermined value, the frequency controller lowers a carrier frequency of the other electric motor.

6. The electronic control device according to claim 5, wherein after decreasing a torque command to the other electric motor to the predetermined value, and when a relationship between a torque command and a rotation speed of the one electric motor reaches an upper limit of an operating range of the one electric motor, the torque controller increases a torque command to the other electric motor.
